(19) United States
(12) Patent Application Publication
(10) Pub. No.: US 2015/0372425 A1
(43) Pub. Date: Dec. 24, 2015

(54) CUSTOM ORIENTATION OF SOCKET PINS TO ACHIEVE HIGH ISOLATION BETWEEN CHANNELS WITHOUT ADDING EXTRA REFERENCE PINS

(71) Applicant: QUALCOMM Incorporated, San Diego, CA (US)

(72) Inventors: Siamak FAZELPOUR, San Diego, CA (US); Charles David PAYNTER, Encinitas, CA (US); Ryan David LANE, San Diego, CA (US)

(21) Appl. No.: 14/313,133

(22) Filed: Jun. 24, 2014

(51) Int. Cl. H01R 13/6461

(52) U.S. Cl. CPC H01R 13/6461

(57) ABSTRACT

Methods and apparatuses for reducing crosstalk. The method couples a first pin, having a first magnetic field direction, with a first socket. The method couples a second pin, having a second magnetic field direction, in a second socket. The method orients the first pin approximately orthogonally to the second pin such that the first magnetic field direction and the second magnetic field direction are approximately orthogonally oriented.

### BACKGROUND OF THE INVENTION

1. Field of the Invention

Disclosed embodiments relate to socket pin orientation.

2. Description of the Related Art

Electronic equipment, such as computers and communication devices often use a processor that is mounted in a socket. The socket is, in turn, mounted on a motherboard, such as a printed circuit board that connects the processor to other components. Several other devices on the motherboard may also use a socket, depending on the particular design. The socket allows the processor to be installed safely on the motherboard and allows the processor to be replaced with a faster or different model or as a repair. In some connections, the processor has a large number of pins or contact pads that electrically connect to a corresponding set of interconnects in the form of pins or contact pads on the socket. The interconnects on the socket can be spring loaded or designed to have some resilience. The springiness can allow all of the interconnects to make a clean connection even if the processor pins are not all perfectly aligned or if the processor's package is not flat.

The high speed of the data that is routed through interconnects on the socket require interconnects with clean electrical properties. With higher speed data, the electrical requirements can include impedance matching, low insertion loss and low cross-talk. These and other electrical effects can interfere with the data, making it unusable by the processor or by a device with which the processor is trying to communicate. However, signal speed through the socket interconnect continues to increase significantly. Increases in speed place increasingly difficult requirements on the interconnects. With higher frequency data signals, the package and socket vertical interconnect may limit the speed at which data can be communicated.

Two reasons that vertical interconnects can degrade the I/O (input/output) performance of a computer system are impedance mismatch between the processor and the socket and cross-talk between the socket pins. The cross-talk can be generated by inductive coupling between pins and capacitive coupling between pins. Inductive coupling is caused by the mutual inductance between two adjacent conductors, in this case, the interconnects or pins. Capacitive coupling is due to the mutual capacitance between the two conductors.

While the mutual capacitance between pins may not be frequency dependent, cross talk caused by mutual inductance can be reduced by reducing the frequency of the signals. However, reducing the data signal frequency can slow data rates that the processor can support. Mutual inductance and mutual capacitance can also be reduced by moving the connectors farther apart, but many processors use the available space for connectors. Mutual inductance and mutual capacitance can also be reduced by reducing the height of the socket pins, but this causes mechanical problems that can limit the connections.

### SUMMARY

The disclosure is directed to socket pin orientation.

An apparatus can comprise a socket. The apparatus can comprise a plurality of pins in the socket. The apparatus can comprise a first pin with a first magnetic field direction. The apparatus can comprise a second pin with a second magnetic field direction, wherein the first pin is capable of being approximately orthogonally oriented to the second pin such that the first magnetic field direction and the second magnetic field direction are approximately orthogonally oriented.

A method for increasing isolation can couple a first pin, having a first magnetic field direction, with a first socket. The method can couple a second pin, having a second magnetic field direction, in a second socket. The method can orient the first pin approximately orthogonally to the second pin such that the first magnetic field direction and the second magnetic field direction are approximately orthogonally oriented.

An apparatus can comprise means for coupling a first pin, having a first magnetic field direction, with a first socket; means for coupling a second pin, having a second magnetic field direction, in a second socket. The apparatus can comprise means for orienting the first pin approximately orthogonally to the second pin such that the first magnetic field direction and the second magnetic field direction are approximately orthogonally oriented.

Orienting pins in sockets such that there is orthogonal orientation may result in a reduction of crosstalk. The pins can be in a differential or single ended pair. In some embodiments, crosstalk may be reduced when differential pairs or single ended pairs are oriented orthogonally as compared to pins oriented in a parallel orientation.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1A illustrates a perspective-view of a conventional unit of pins in a socket in a parallel orientation.

FIG. 1B illustrates a perspective-view of a unit of pins in a socket in an orthogonal orientation.

FIG. 2A illustrates a perspective-view of two conventional adjacent units of pins in a socket in a parallel orientation.

FIG. 2B illustrates a perspective-view of two adjacent units of pins in a socket in an orthogonal orientation.

FIG. 3A illustrates a perspective-view of two conventional adjacent units of pins in a socket in a parallel orientation.

FIG. 3B illustrates a perspective-view of two adjacent units of pins in a socket in an orthogonal orientation.

FIG. 4 illustrates an operational flow of a method for increasing isolation between channels.

FIG. 5 illustrates a graphical representation of baseline differential cross-talk of parallel pin differential pairs.

FIG. 6 illustrates a graphical representation of differential cross-talk of differential orthogonally oriented pairs of pins.

FIG. 7 illustrates a graphical representation of cross-talk of single ended parallel pins.

FIG. 8 illustrates a graphical representation of cross-talk of single ended orthogonally oriented pairs of pins.

FIG. 9 illustrates a block diagram showing an exemplary wireless communication system.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

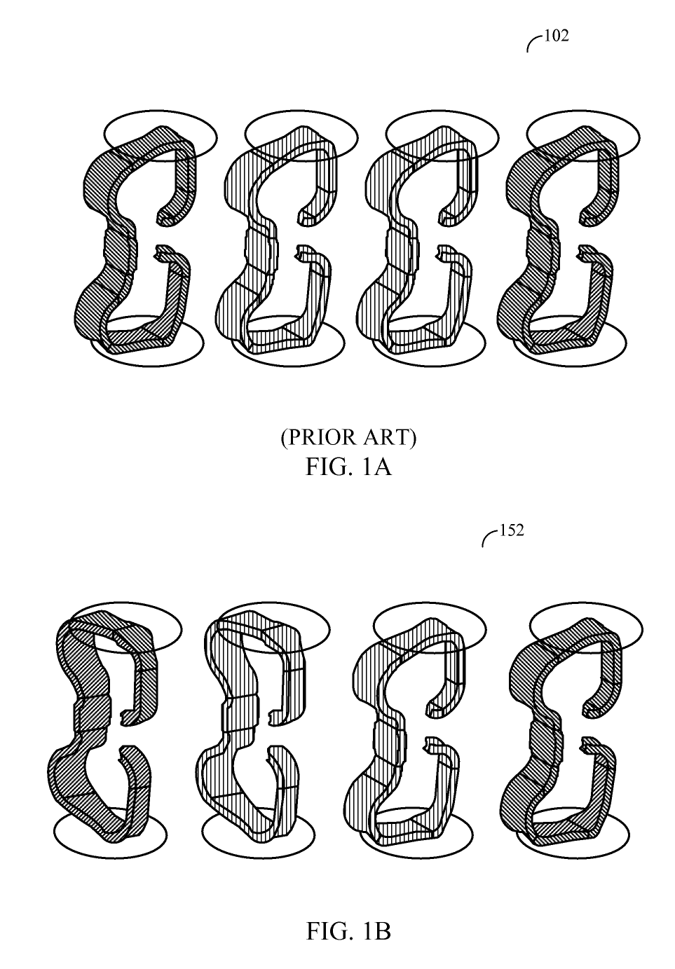

FIG. 1A illustrates a perspective-view of an apparatus with a conventional unit of pins, comprising a plurality of pins, in a socket in a parallel orientation. In a conventional unit of pins 102, the pins face in the same direction in the y and z axis while distributed along the x axis in a parallel pattern.

FIG. 1B illustrates a perspective-view of an apparatus with a unit of pins, comprising a plurality of pins, in a socket in an orthogonal orientation. In the orthogonal unit of pins 152, the pins share the same direction in the z axis, but are offset 90 degrees in the y axis. The pins are distributed along the x-axis in a parallel pattern.

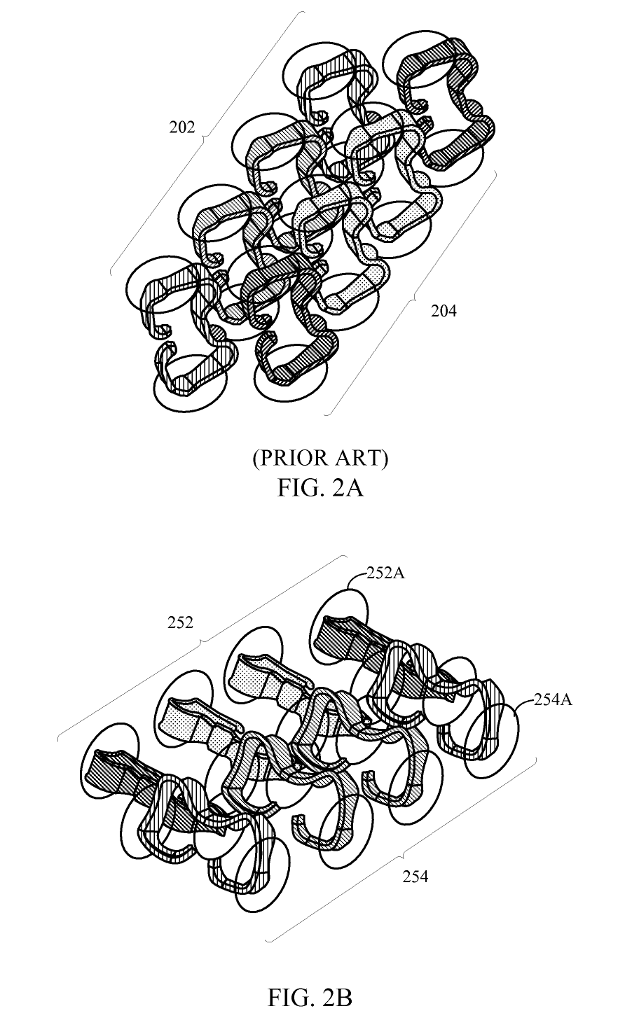

FIG. 2A illustrates a perspective-view of an apparatus with two conventional adjacent units of pins, each comprising a plurality of pins, in a socket in a parallel orientation. The first unit of pins 202 face in the same direction in the y and z axis. The second unit of pins 204 face in the same direction in the y and z axis. The first unit of pins 202 and the second unit of pins 204 are shown as being adjacent to each other.

FIG. 2B illustrates a perspective-view an apparatus with of two adjacent units of pins, each comprising a plurality of pins, in a socket in an orthogonal orientation. The first unit of pins 252 face in the same direction in the y and z axis. The second unit of pins 254 face in the same direction in the y and z axis, but all of the pins in the first unit of pins 252 are offset 90 degrees in the y axis from the pins in the second unit of pins 254. The first unit of pins 252 and the second unit of pins 254 are shown as being adjacent to each other.

In some embodiments, a first pin 252A of the first unit of pins 252 can be coupled to a first socket such that it is orthogonally oriented to a second pin 254A of the second unit of pins 254 coupled to a second socket. The first pin 252A can receive a first signal, and the second pin 254A can receive a second signal. The first pin 252A and the second pin 254A can be an adjacent differential pair with complementary signals. For example, the first pin 252A and the second pin 254A can be non-ground elements. The first pin 252A and the second pin 254A can be a single ended signal pair. For example, the first pin 252A can be coupled to ground.

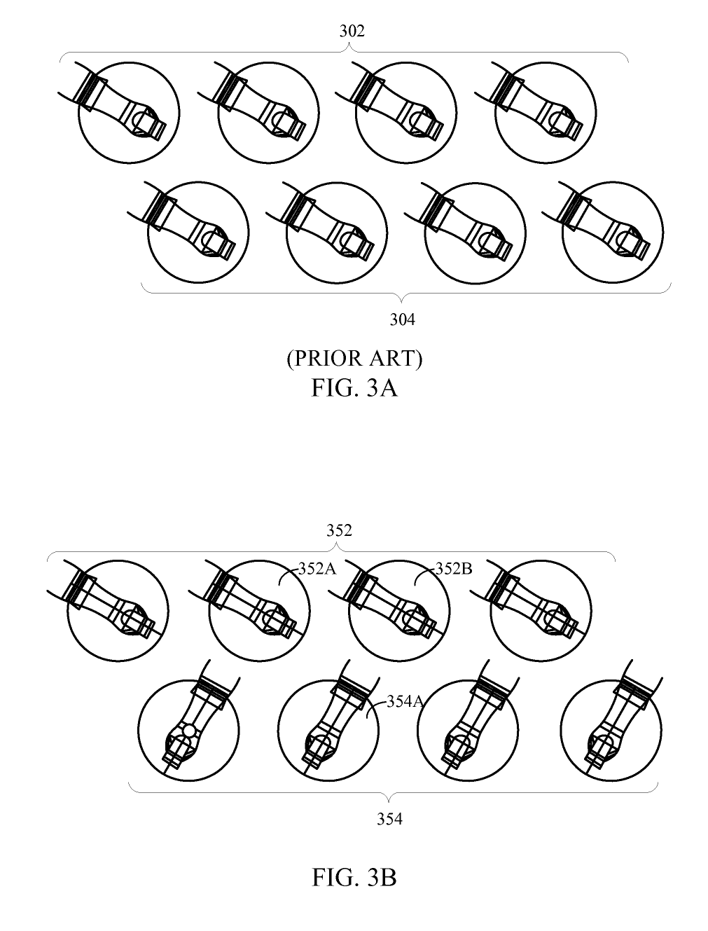

FIG. 3A illustrates a perspective-view of an apparatus with two conventional adjacent units of pins, each comprising a plurality of pins, in a socket in a parallel orientation. The first unit of pins 304 face in the same direction in the y and z axis. The second unit of pins 306 face in the same direction in the y and z axis. The first unit of pins 304 and the second unit of pins 306 are shown as being adjacent to each other.

FIG. 3B illustrates a perspective-view of an apparatus with two adjacent units of pins, each comprising a plurality of pins, in a socket in an orthogonal orientation. The first unit of pins 352 face in the same direction in the y and z axis. The second unit of pins 354 face in the same direction in the y and z axis, but all of the pins in the first unit of pins 352 are offset 90 degrees in the y axis from the pins in the second unit of pins 354. The first unit of pins 352 and the second unit of pins 354 are shown as being adjacent to each other. A first pin 352A of the first unit of pins 352 and a second pin 354A of the second unit of pins 354 can be adjacent to each other. The second pin 354A can be also adjacent to a next pin 352B of the first set of pins 352. The second pin 354A can be approximately equidistant from the first pin 352A and the next pin 352B. As shown, the first unit of pins 352 can be oriented in the same direction as the first pin 352A and the second unit of pins 354 can be oriented in the same direction as the second pin 354A.

In some embodiments, the first pin 352A and the second pin 354A can be a single ended signal pair, where one of the first pin 352A or the second pin 354A is coupled to a reference voltage. In some embodiments, the first pin 352A can be coupled to ground. In some embodiments, the second pin 354A can be coupled to ground. In some embodiments, neither the first pin 352A nor the second pin 354A may be non ground elements. In some embodiments, a package and a printed circuit board (PCB) can be included.

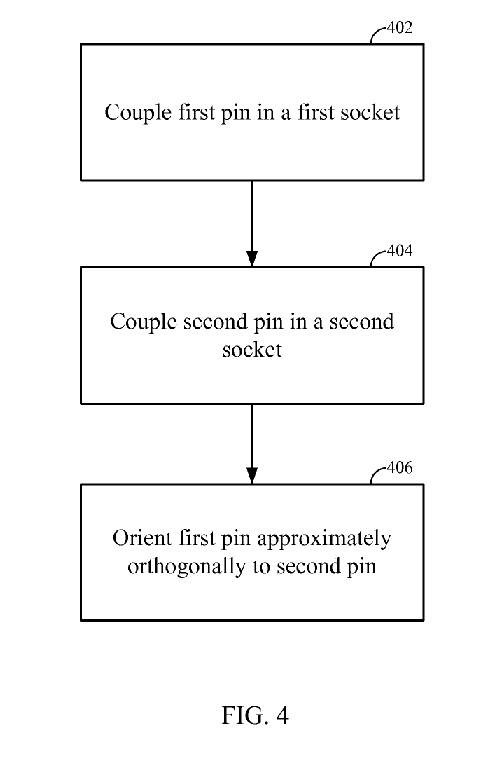

FIG. 4 illustrates an embodiment that can include a method for increasing isolation between channels, the method comprising: coupling a first pin, having a first magnetic field direction, with a first socket—Block 402; coupling a second pin, having a second magnetic field direction, in a second socket—Block 404; and orienting the first pin approximately orthogonally to the second pin such that the first magnetic field direction and the second magnetic field direction are approximately orthogonally oriented—Block 406. In

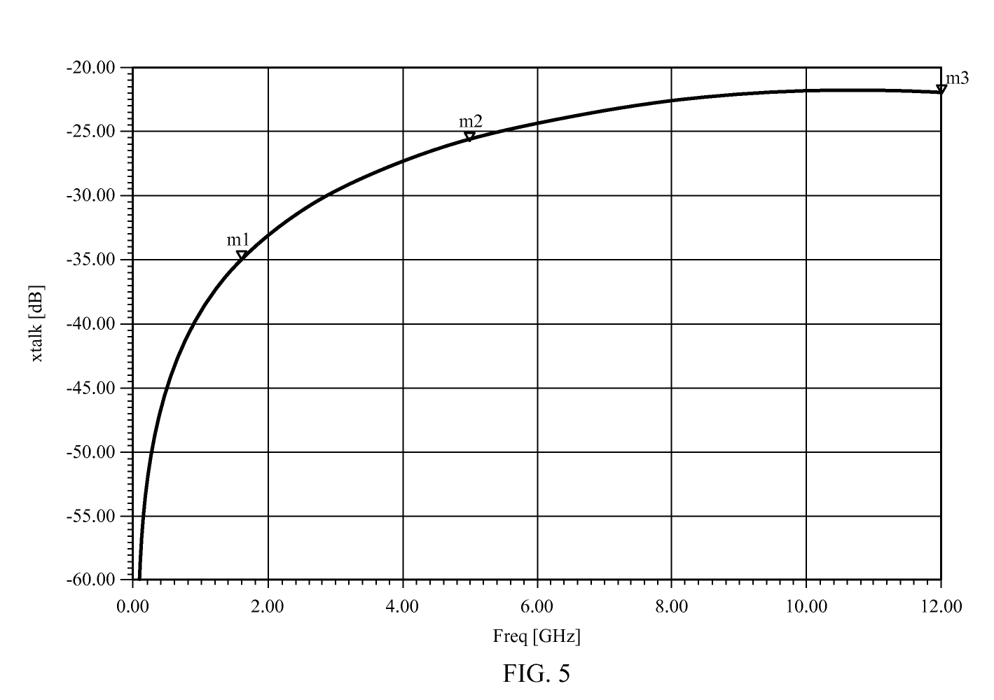

FIG. 5 illustrates a graphical representation of baseline differential cross-talk of parallel pin differential pairs. m1 at 1.6 GHz represents a data rate of a memory interface. m2 at 5 GHz represents a data rate at a second memory interface. m3 at 12 GHz represents a data rate at a third memory interface. As shown with m1 as compared to m2, the increase in crosstalk can be approximately 10 dB from −34.9184 dB to −25.6112 dB when frequency increases by 3.4 GHz. In FIG. 5, crosstalk increases by approximately 4 dB from −25.6112 dB to −21.9324 dB from m2 to m3 when frequency increases by 7 GHz.

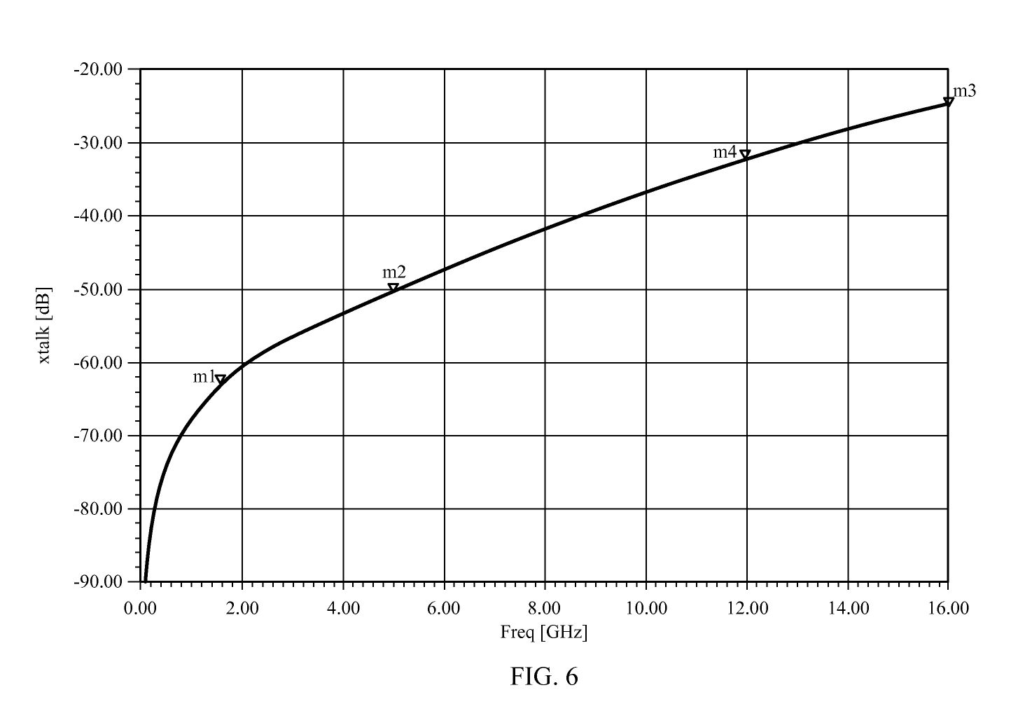

FIG. 6 illustrates a graphical representation of differential cross-talk of differential orthogonally oriented pairs of pins. Comparing differential cross-talk of FIGS. 5 and 6 shows reduction of crosstalk at frequencies up to 12 GHz. In the graphical representations, improvement is shown as 28 dB at 1.6 GHz, 24.7 dB at 5 GHz and 10.3 dB at 12 GHz. As shown with m1 as compared to m2, the increase in crosstalk can be approximately 13 dB from −62.9171 dB to −50.3215 dB when frequency increases by 3.4 GHz. In FIG. 6, crosstalk increases by approximately 18 dB from −50.3215 dB to −24.9734 dB from m2 to m3 when frequency increases by 11 GHz. FIG. 5 also shows m3 as compared to m4, where the decrease in crosstalk can be approximately −7 dB from −24.9734 dB to −32.1650 dB when the frequency decreases by 4 GHz.

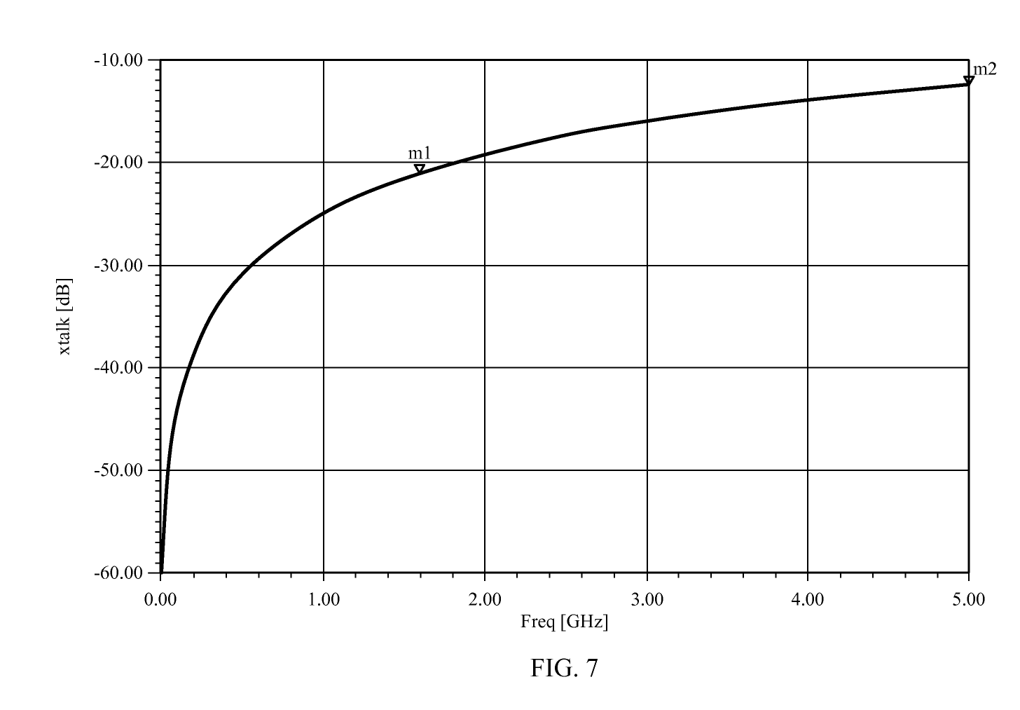

FIG. 7 illustrates a graphical representation of cross-talk of single ended parallel pins. As shown with m1 as compared to m2, the increase in crosstalk can be approximately 8.5 dB from −21.0868 dB to −12.5183 dB when frequency increases by 3.4 GHz.

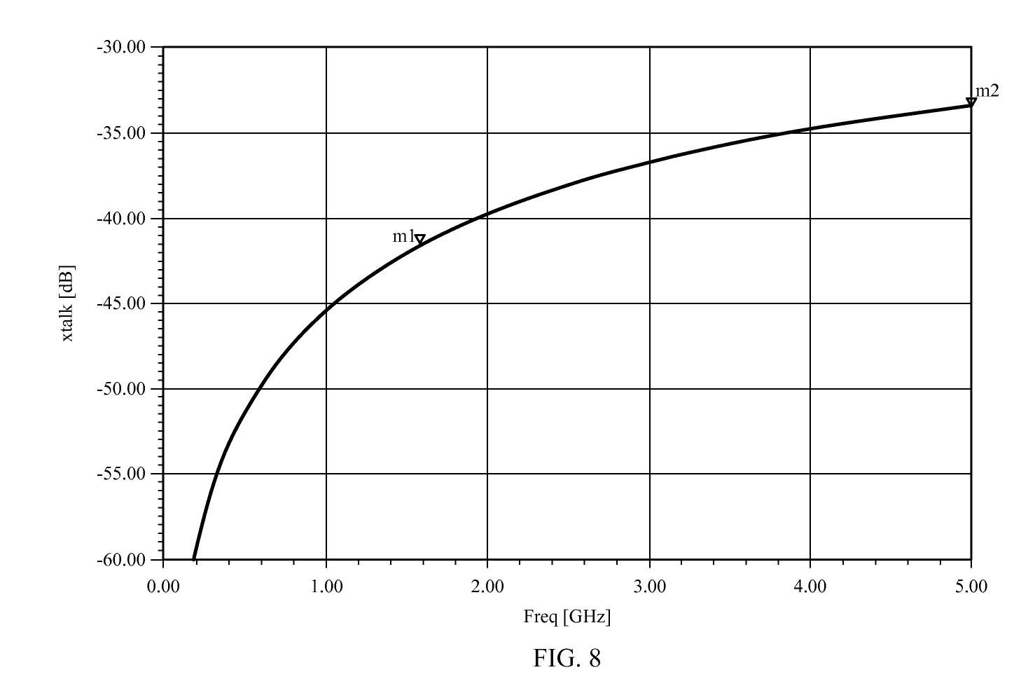

FIG. 8 illustrates a graphical representation of cross-talk of single ended orthogonally oriented pairs of pins. Comparing data shown in FIG. 7 to data in FIG. 8, crosstalk reduction occurs at frequencies up to 5 GHz. As shown in these figures, crosstalk is reduced by 20.4 dB at 1.6 GHz and 20.9 dB at 5 GHz. As shown with m1 as compared to m2, the increase in crosstalk can be approximately 8 dB from −41.5460 dB to −33.3999 dB when frequency increases by 3.4 GHz.

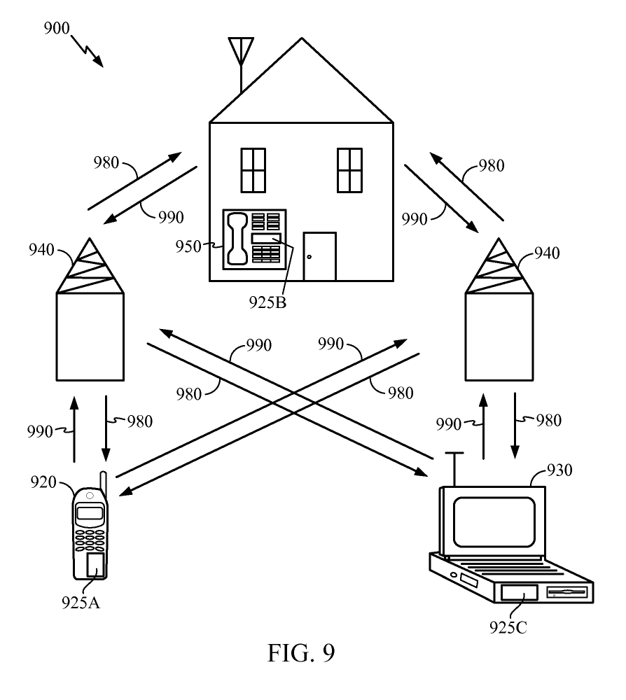

FIG. 9 is a block diagram showing an exemplary wireless communication system 900 in which an embodiment of the disclosure may be advantageously employed. For purposes of illustration, FIG. 9 shows three remote units 920, 930, and 950 and two base stations 940. It will be recognized that wireless communication systems may have many more remote units and base stations. Remote units 920, 930, and 950 include IC devices 925A, 925B and 925C, as disclosed below. It will be recognized that any device containing an IC may also include an orthogonally oriented socket pin apparatus having the disclosed features and/or components manufactured by the processes disclosed here, including the base stations, switching devices, and network equipment. FIG. 9 shows forward link signals 980 from the base station 940 to the remote units 920, 930, and 950 and reverse link signals 990 from the remote units 920, 930, and 950 to base stations 940.

In FIG. 9, the remote unit 920 is shown as a mobile telephone, the remote unit 930 is shown as a portable computer, and the remote unit 950 is shown as a fixed location remote unit in a wireless local loop system. For example, the remote units may be a device such as a music player, a video player, an entertainment unit, a navigation device, a communications device, a personal digital assistant (PDA), a fixed location data unit, and a computer. Although FIG. 9 illustrates remote units according to the teachings of the disclosure, the disclosure is not limited to these exemplary illustrated units. The disclosure may be suitably employed in any device which includes an orthogonally oriented socket pin apparatus, as described above.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an electronic object. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. An apparatus comprising:
a socket;
a plurality of pins in the socket;
a first pin with a first magnetic field direction; and
a second pin with a second magnetic field direction,
wherein the first pin is capable of being approximately orthogonally oriented to the second pin such that the first magnetic field direction and the second magnetic field direction are approximately orthogonally oriented.

2. The apparatus of claim 1, wherein the first pin and the second pin are an adjacent differential pair.

3. The apparatus of claim 1, wherein the first pin and the second pin are a single ended signal pair.

4. The apparatus of claim 1, wherein the first pin is coupled to ground.

5. The apparatus of claim 1, wherein the first pin and the second pin are non-ground elements.

6. The apparatus of claim 1, wherein the first pin comprises a first unit of pins and the second pin is adjacent to the first pin and a next pin of the first unit of pins.

7. The apparatus of claim 6, wherein the second pin is approximately equidistant from the first pin and the next pin.

8. The apparatus of claim 6, wherein the second pin comprises a second unit of pins.

9. The apparatus of claim 8, wherein the first unit of pins are oriented in the same direction as the first pin and the second unit of pins are oriented in the same direction as the second pin.

10. The apparatus of claim 1, further comprising a package and a printed circuit board (PCB).

11. A method for increasing isolation, the method comprising:
coupling a first pin, having a first magnetic field direction, with a first socket;
coupling a second pin, having a second magnetic field direction, in a second socket; and
orienting the first pin approximately orthogonally to the second pin such that the first magnetic field direction and the second magnetic field direction are approximately orthogonally oriented.

12. The method of claim 11, further comprising transmitting a first signal on the first pin and a second signal, wherein the second signal is complementary to the first signal, on the second pin.

13. The method of claim 11, further transmitting a reference voltage on one of the first pin or the second pin.

14. The method of claim 11, further comprising coupling the first pin to ground.

15. The method of claim 11, further comprising coupling the first pin and the second pin to non-ground elements.

16. The method of claim 11, further comprising orienting the second pin adjacent to the first pin and a next pin, wherein a first unit of pins is comprised of the first pin and the next pin.

17. The method of claim 16, further comprising orienting the second pin approximately equidistant from the first pin and the next pin.

18. The method of claim 16, wherein a second unit of pins is comprised of the second pin.

19. The method of claim 18, further comprising orienting the first unit of pins in the same direction as the first pin and orienting the second unit of pins in the same direction as the second pin.

20. An apparatus comprising:
means for coupling a first pin, having a first magnetic field direction, with a first socket;
means for coupling a second pin, having a second magnetic field direction, in a second socket, and
means for orienting the first pin approximately orthogonally to the second pin such that the first magnetic field direction and the second magnetic field direction are approximately orthogonally oriented.
